(19) United States
(12) Patent Application Publication
(10) Pub. No.: US 2026/0249120 A1
(43) Pub. Date: Aug. 27, 2026

(54) AN INTELLIGENT, MODULAR FIRE EXTINGUISHING UNIT

(71) Applicant: INTEGRATED FIRE SYSTEMS (PTY) LIMITED, Northriding (ZA)

(72) Inventor: Stefan SWANEPOEL, Northriding (ZA)

(21) Appl. No.: 18/995,199

(22) PCT Filed: Jul. 10, 2023
(86) PCT No.: PCT/IB2023/057056

§ 371 Date: Jan. 16, 2025

(30) Foreign Application Priority Data
Jul. 20, 2022 (ZA) 2022/08059

(51) Int. Cl. A62C 35/02; A62C 5/02; A62C 35/13

(52) U.S. Cl. CPC A62C 35/023; A62C 5/022; A62C 35/13

(57) ABSTRACT

The invention relates to an intelligent, independently-powered, modular fire extinguishing unit suitable for retrofitting to existing infrastructures. The unit comprises at least one independently pressurised gas chamber; at least one non-pressurised fire suppressant reservoir arranged in flow communication with the pressurised gas chamber and containing a fire suppressant; a digital control module for actuating pressure release from the gas chamber into the fire suppressant reservoir to pressurise the fire suppressant; discharge means arranged in flow communication with the fire suppressant reservoir through which pressurised fire suppressant is discharged; and a unit-dedicated on-site power supply source for actuating the unit in the event of a fire.

### INTRODUCTION

The invention relates to an intelligent, independently-powered, modular fire extinguishing unit particularly suitable for use in, amongst others, building and industrial structures. The unit is designed for automatic actuation in the event of a digital signal or automatic physical trigger, coupled with remote manual activation and is adapted for retro-fitting to existing infrastructures.

### BACKGROUND TO THE INVENTION

Insurance companies are applying increased pressure on small, medium and large businesses to install expansive automated fire detection and suppression systems in their building structures, such as office blocks, manufacturing plants, industrial sites and warehouses, or simply declining to accept risks without such systems. Retro-fitting of such systems to existing infrastructures is a very expensive and labour-intensive process that places a massive burden on companies, as well as the economy as a whole, through a reduction of insurance capacity and cover for businesses that do not comply, leaving such businesses exposed to prolonged interruptions and potential business failure in the event of a fire.

Conventional suppression systems such as an automatic fire sprinkler system is designed to contain and control an unfriendly fire. Types of water-based sprinkler systems permissible by NFPA 13, Standard for the Installation of Sprinkler Systems, are wet, dry, pre-action, and deluge. The systems differ in their mechanical release mechanisms and installations, but they all comprise a network of sprinkler piping which starts at a reliable water supply source and ends with strategically spaced fire sprinkler heads located throughout a building structure. When a blaze ignites, air directly above it heats rapidly. This hot air rises and spreads along a ceiling, and once the air is hot enough and reaches a sprinkler head, it triggers a chain reaction. Most sprinkler heads feature a glass bulb filled with a glycerine-based liquid. This liquid expands when it comes into contact with heated air, shattering its glass confines to activate a sprinkler head, which opens a valve, allowing pressurized water from the piping system to be propelled out over an entire designated area.

Water-based sprinkler systems are the most reliable and cost effective under specific circumstances, but they suffer from a number of disadvantages. They are not usable in areas where temperatures can drop below 4° C. since water in the pipes can freeze. It is important for the water in such systems to be pressurized, and for the pipes to be connected to a reliable water source. Accordingly, such systems are rendered impractical in areas with unreliable or inadequate water supply or water storage facilities, or interrupted power supply. Moreover, it is technically difficult and quite expensive to retro-fit such systems to existing building structures. Also, these systems are indiscriminatory in their application in that they are not typically designed to douse only small specific areas, but instead douse large, designated areas even if only a small fire is detected, sometimes leading to more damage caused by the sprinkler water than by the fire.

An alternative fire extinguishing system is a Compressed Air Foam System (CAFS), which is a standard water pumping system that comprises a self-contained stored-energy fire suppression unit that has the ability to inject compressed air into a foam solution to generate a powerful fire attacking and suppressant foam. An air compressor also provides energy, which propels compressed air foam further than aspirated or standard water nozzles. CAFS may also refer to any pressurized water style extinguisher that is charged with foam and pressurized with compressed air. Standard CAFS still typically relies on reliable and sufficient water supply and storage, as well as uninterrupted power supply. Moreover, it is very difficult to retrofit a CAFS to an existing building structure, particularly since the CAFS must be installed and maintained under constant high pressure throughout the system.

Yet an alternative system is a nitrogen fire suppression system, which utilizes pure nitrogen that operates as a fire suppressant by reducing the oxygen content within a room to a point at which a fire will extinguish. However, these systems are expensive as they require large, pre-compressed tanks, and they are difficult to retrofit to existing structures. Moreover, nitrogen gas is colourless and odourless so it can have severe effects on a human body without being noticed, particularly asphyxiation in the absence of adequate ventilation, and contact with liquid nitrogen or cold nitrogen gas can cause freezing of exposed tissue.

It is accordingly an object of the present invention to provide an intelligent, independently-powered, cost-effective fire sprinkler unit and integrated system for automatic actuation in the event of a fire, which is adapted to site-specific dousing regimes (i.e., is rational fire design-based), and which can be retro-fitted to existing infrastructures.

### SUMMARY OF THE INVENTION

According to the invention there is provided an intelligent, independently-powered, modular fire extinguishing unit suitable for, although not limited to, retrofitting to existing building structures, the unit comprising—
at least one independently pressurised gas chamber;
at least one non-pressurised fire suppressant reservoir arranged in flow communication with the pressurised gas chamber and containing a fire suppressant;
a digital control module for actuating pressure release from the gas chamber into the fire suppressant reservoir to pressurise the fire suppressant;
discharge means arranged in flow communication with the fire suppressant reservoir through which pressurised fire suppressant is discharged; and
a unit-dedicated on-site power supply source for actuating the unit in the event of a fire.

The pressurised gas chamber may be a compressed air cylinder of which the cylinder volume is tailored to the volume of the fire suppressant reservoir, as well as to the particular fire suppressant being used. The gas chamber may removably be connectable to the suppressant reservoir and discharge means to facilitate easy servicing and repressurising without compromising or activating the unit. The gas chamber may be filled with compressed air, compressed nitrogen or a combination of air and nitrogen.

The fire suppressant reservoir may have a volume that is tailored to a potential fire load, the selected fire suppressant, and mounting weight limitations. Discharge from the fire suppressant reservoir may be achieved through pressure from the pressurised gas chamber. The fire suppressant reservoir may removably be connectable to the gas chamber and discharge means to facilitate easy servicing and refilling without compromising or activating the unit.

The fire suppressant may be water, CAF (compressed air foam), or any other suitable fire suppressant used in the market and responsive to injection of pressurised air. In one embodiment of the invention, the fire suppressant reservoir is filled with compressed air foam; and the unit includes a separate mobile water reservoir arranged in flow communication with both the pressurised gas chamber and the fire suppressant reservoir such that water from the water reservoir is mixed with the fire suppressant to form a fire suppressant foam. Those who are engaged in the industry will appreciate that compressed air foam (such as aqueous film forming foam or AFFF) is mixed with water to produce a fire suppressant foam.

The digital control module may control actuation of the unit and may provide at least four levels of actuation, including heat-only automatic activation, smoke/heat and digital-input automatic activation, manual activation and deactivation as a stand-alone unit, and manual activation and deactivation as an integrated system comprising a number of units according to the invention.

The heat-only automatic activation may provide actuation of the unit under detection of a heat signal, similar to prior art suppression systems.

For the heat and digital-input automatic activation functionality, the unit according to the invention may include heat cameras, infrared or optical sensors, such as ember detectors, designed to detect radiant energy emitted by burning or glowing particles, or the like early-detection sensors, smoke heat detectors and/or temperature sensors, such that the unit is automatically actuated in the event of such early detection, with a heat-only activation constituting an overriding automatic activation. The digital-input activation functionality may include signalling means for signalling unit activation such as LED lights, a sounding alarm, a SMS/WhatsApp message/push/telegram notifications to one or more dedicated receivers. The automatic mechanical actuation can also send digital signals via on board switching when the valves change state as a result of activation, if the digital control unit is not compromised in any way.

The manual activation and deactivation functionality may be done on a unit-specific basis or may be done on an integrated system comprising a number of series or parallel linked units according to the invention. Such manual operation may provide hard-wired on-site activation buttons, wall mounted remote transmitter buttons, levers or the like; or may done through remote activation via a cell phone application. The manual deactivation functionality enables individual servicing of a unit without affecting operational status or functionality of the remaining units in an integrated system. Manual activations may be pre-grouped to focus on high-risk areas of ignition or fire spread potential, or precautionary dousing requirements. The control module may be adapted to accommodate synchronous activation of a number of inter-connected units.

The discharge means may include a foam generator; and an activation and pressurisation manifold designed to receive pressure-driven fire suppressant and additional pressurisation from the gas chamber. The foam generator may include a mixing chamber for receiving and mixing water, fire suppressant foam and pressurised air in predetermined ratios; and a mesh chamber for causing turbulent flow and cavitation to form the compressed fire suppressant foam.

The manifold may terminate in a series of sprinklers. The manifold may be adapted to both wet and dry suppressant and include a manual suppressant change setting to change the manifold between wet and dry suppressant. The sprinklers may be arranged depending on the area to be doused, such as staggered inline sprinklers for conveyer belt dousing, close proximity sprinklers for overlapping dousing, or standard dispersion layout.

The power supply source may be a rechargeable battery that is connected to an electricity supply or a solar panel.

The unit may include a heat-resistant mounting cradle which may provide for a number of linear or angular mounting options, including direct mounting to a ceiling, suspension from a ceiling, or mounting to an upright wall.

The invention extends to an integrated fire suppression system comprising a number of units according to the invention arranged in series or parallel throughout a building structure.

### SPECIFIC EMBODIMENT OF THE INVENTION

Without limiting the scope thereof, one embodiment of the invention will now further be described and exemplified with reference to the accompanying drawings in which:—

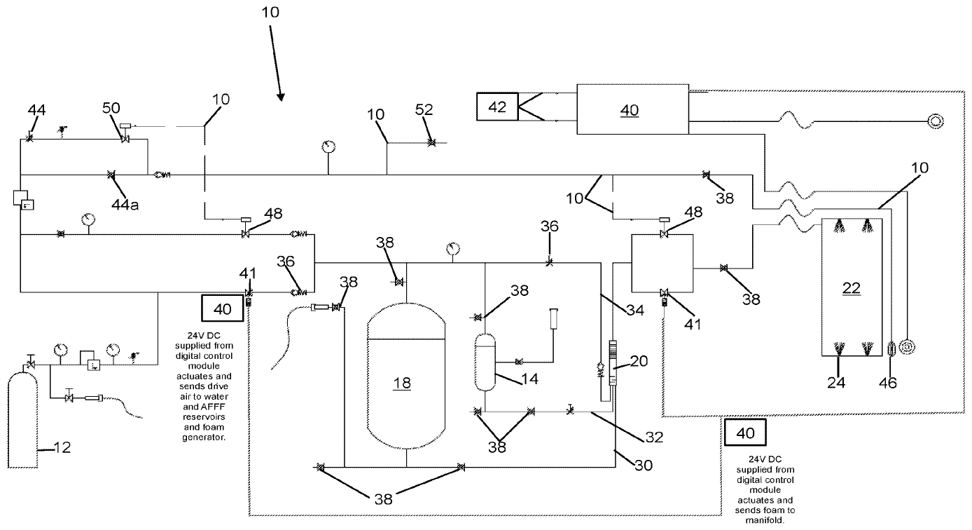

FIG. 1 is a schematic illustration of a fire extinguishing unit (10) according to the invention;

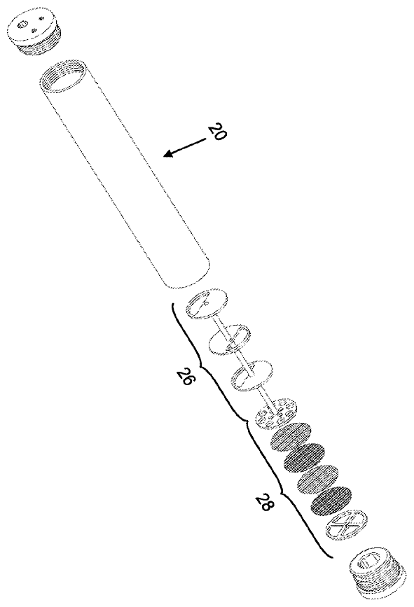

FIG. 2 is an exploded isometric view of a foam generator (20) used in the fire extinguishing unit of the invention; and

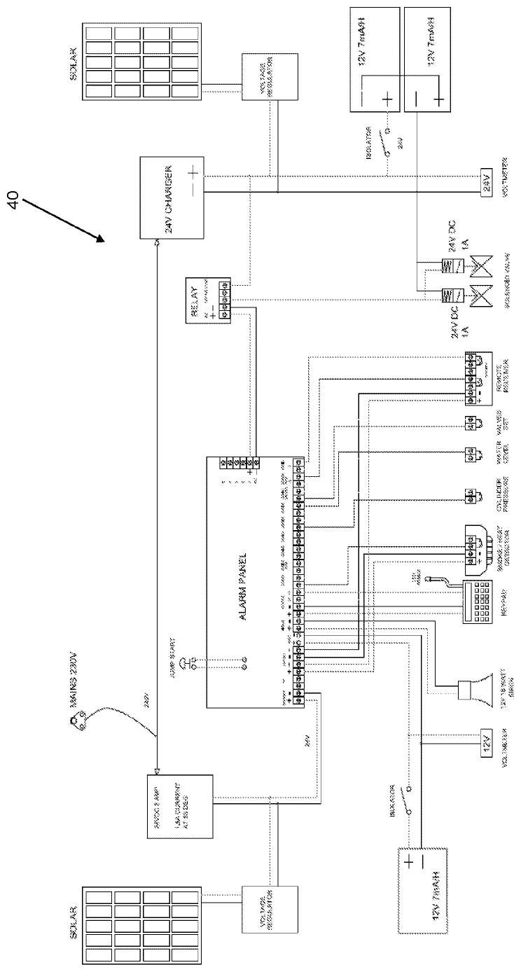

FIG. 3 is an electrical schematic representing the digital control module (40) of the fire extinguishing unit.

Unless otherwise defined, all the technical and scientific terms used herein have the same meanings as commonly understood by one of ordinary skill in the art to which the present disclosure belongs. The terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, “connecting”, etc., are not intended only to define a physical connection or mechanical connection, but may include an electrical connection, directly or indirectly.

A fire extinguishing unit according to the invention is generally designated by reference numeral (10). It comprises at least one independently pressurised gas chamber (12); at least one non-pressurised fire suppressant reservoir (14) which is arranged in flow communication with the pressurised gas chamber (12) and containing a fire suppressant; and a water reservoir (18). The fire extinguishing unit (10) further comprises a foam generator (20); and an activation and pressurisation manifold (22) through which compressed fire suppressant foam (24) is discharged.

Referring to FIG. 2, the foam generator (20) includes a mixing chamber (26) for receiving and mixing water, fire suppressant foam and pressurised air in predetermined ratios; and a mesh chamber (28) for causing turbulent flow and cavitation to form the compressed fire suppressant foam. Three balanced pressure lines (30; 32; 34) respectively carry water from the water reservoir (18), fire suppressant from the fire suppressant reservoir (14), and air and/or nitrogen from the gas reservoir (12) into the first mixing chamber (26) of the foam generator (20), where the water, fire suppressant and air/nitrogen are mixed together at predetermined ratios. The air/nitrogen line (34) and fire suppressant line (32) are fitted with a plurality of metering valves (36) in line between the respective reservoirs (12; 14) and the foam generator (20), so that flow can be adjusted as desired to attain a preferred foam structure.

When nitrogen is used as opposed to air, an inert nitrogen foam blanket is created that contains no oxygen and the nitrogen is contained inside the foam structure. Since this process happens inside a pressurized vessel (20), the mixture is not air-aspirated like in the case of conventional foam sprinkler systems (as would normally happen at manifold (22) as it exits with the use of sprinklers with limited pressure and flow capabilities), which enables the foam to be expelled at a greater pressure than conventional systems due to no backpressure as normally associated with venturi systems where discharge pipe length is limited because it affects the venturi capacity. Due to the corrosive nature of AFFF the foam generator (20), the generator shell, internal components and pipe work are manufactured from 304 grade stainless steel. The unit (10) is fitted with service valves (38) to drain and flush the pipe work after activation, first with fresh water and then with air, to rid the pipe work of any foam mix residue that can dry and clog or restrict the pipe work. This can also aid in periodic testing of the manifold (22) to ensure it's free from blockages.

The unit (10) further includes a digital control module (40) for actuating pressure release from the gas chamber (12) into the suppressant reservoir (14) to pressurise the fire suppressant (16); and a unit-dedicated on-site power supply source (42) for actuating the electric operated solenoid valves (41) in the event the electronic sensors/camera sense a fire or smoke.

Automatic mechanical activation of the pneumatic system, line (10) functions independently of any electrical system and no electricity is required for this function, provided the pneumatic system is in a state of readiness and armed. A dry pipe system (10) is pressurized with a manual valve (44a) initially, by opening the valve (44a) until line (10) is pressurised. This opens valve (50) enabling metering valve (44) to trickle flow for topping up the line (10) via valve (50) in case of any leakages which may lead to a false actuation. An end-of-line sensor (46) is a mechanical sprinkler head, a glass vial filled with liquid that erupts at a predetermined temperature, in this case 68° C. This causes the pressurised line (10) to lose pressure faster than the metering valve (44) can keep up and spring return valves (48) held shut by the pressure in line (10) will open the valves (48) holding back stored water, AFFF and HP reduced air/nitrogen. Accordingly, the system is activated, and foam is expelled. To prevent air/nitrogen loss from the end-of-line sensor (46) that is now an open end, the spring return valve (50) held open by pressure in line (10) will now mechanically spring-return to closed as a result of the pressure drop in line (10), stopping any flow of top-up air/nitrogen into the pressurised line (10) via metering valve (44) which is now open ended. The end-of-line sensor (46) will have to be replaced for line (10) to be sealed and pressurised again.

In addition to the end-of-line sensor (46) erupting, the system can also be activated manually by opening a vent valve or manual activation valve (52) that vents the line (10) pressure, resulting in the same condition as a ruptured glass vial. In this case the system can be armed again by simply closing the valve (52) without the need to replace the spent end-of-line sensor (46) and line (10) can be charged again to a state of readiness.

It will be appreciated that since the line (10) according to the invention is independently pressurised and independently powered from gas chamber (12), it is not dependent on pumps or external electricity feed and will not fail in the event of interrupted electricity supply. The unit (10) can be retrofitted with ease in areas where infrastructural services may be limited or intermittent. Individual size and weight of the unit (10) allows mounting of the unit (10) to most construction elements, such as roof beams, trusses and columns, as well as retro-fitment in smaller areas where the effective control of ignition sites is critical in reducing the incidence of fires through early detection and extinguishing of ignition sources.

The unit (10) of the invention allows the installation of an integrated, focused, hierarch-driven system of units and a resultant network of sprinklers that can be installed to maximise early-detection and fire-fighting benefits, whilst avoiding dousing of suppressant-sensitive inventory or equipment that are not threatened by fire. Baseline automation ensures that the system operates as a standard sprinkler system as a minimum operational feature under all circumstances. Conventional suppressants can be used, avoiding the release of hazardous or oxygen-depleting chemicals that can cause human harm.

Each unit (10) is a standalone unit, independent from other units (10) in the system, and as such do not require inter-unit suppressant supply or electricity feed. No complex and expensive piping is required, which significantly reduces installation costs and facilitates on-site retro-fitting. The ability to link other input devices (such as cameras and sensors) into the activation hierarchy, allows response to a greater variety of triggers compared to conventional sprinkler systems, without sacrificing baseline automatic response of sprinklers, when required. The focused use of suppressant reduces the need for suppressant that may be scarce or intermittently available since specific areas can be doused without the need to douse an entire site. All components within the unit (10) can be serviced independently and easily, thus reducing maintenance costs. Since the entire system is not under constant pressure, separate units (10) or components of units (10) can be dismantled and serviced without the need for complicated shut-off and bleeding procedures, and without compromising the remainder of the system.

It will be appreciated that alternative embodiment of the invention may be possible without departing from the spirit or scope of the invention as defined in the claims.

1. An intelligent, independently-powered, modular fire extinguishing unit (10) suitable for, although not limited to, retrofitting to existing infrastructures, the unit (10) comprising—
at least one independently pressurised gas chamber (12);
at least one non-pressurised fire suppressant reservoir (14) arranged in flow communication with the pressurised gas chamber (12) and containing a fire suppressant;
a digital control module (40) for actuating pressure release from the gas chamber (12) into the fire suppressant reservoir (14) to pressurise the fire suppressant;
discharge means (20; 22) arranged in flow communication with the fire suppressant reservoir (14) through which pressurised fire suppressant is discharged; and
a unit-dedicated on-site power supply source (42) for actuating the unit (10) in the event of a fire.

2. The fire extinguishing unit (10) according to claim 1 wherein the gas chamber (12), fire suppressant reservoir (14), digital control module (40), discharge means (22), and power supply source (42) are removably connected to each other such that any one of these components are independently removable from the unit (10), serviced, refilled, and/or repressurised without compromising unit integrity or activating the unit (10).

3. The fire extinguishing unit (10) according to claim 1 wherein specific volume of the pressurised gas chamber (12) is tailored to specific volume of the fire suppressant reservoir (14), as well as to a particular fire suppressant being used; while volume of the fire suppressant reservoir (14) is tailored to a potential site-specific fire load, a particular fire suppressant being used, and mounting weight limitations; the unit (10) making it possible interchangeably and alternatingly to connect differently-sized gas chambers (12) and fire suppressant reservoirs (14) to each other depending on varying site-specific requirements.

4. The fire extinguishing unit (10) according to claim 1 wherein the gas chamber (12) is filled with compressed air, compressed nitrogen or a combination of compressed air and nitrogen.

5. The fire extinguishing unit (10) according to claim 1 wherein the unit (10) further includes a water reservoir (16) arranged in flow communication with both the pressurised gas chamber (12) and the fire suppressant reservoir (14) such that water from the water reservoir (16) is mixed on-site and under pressure with compressed air foam in the fire suppressant reservoir (14) to form a pressurised fire suppressant foam (24).

6. The fire extinguishing unit (10) according to claim 1 wherein the discharge means (20; 22) includes a foam generator (20); and an activation and pressurisation manifold (22) that terminates in a series of sprinklers for dispersing pressure-driven fire suppressant (24).

7. The fire extinguishing unit (10) according to claim 6 wherein the foam generator (20) includes a mixing chamber (26) for receiving and mixing water, fire suppressant foam and pressurised air in predetermined ratios; and a mesh chamber (28) for causing turbulent flow and cavitation to form the compressed fire suppressant foam before dispersing the pressurised foam to the manifold (22).

8. The fire extinguishing unit (10) according to claim 1 wherein the digital control module (40) controls actuation of the unit (10) through at least four levels of actuation, including heat-only automatic activation, heat-and digital-input automatic activation, manual activation and deactivation as a stand-alone unit, and manual activation and deactivation as an integrated system comprising a number of units (10).

9. The fire extinguishing unit (10) according to claim 8 wherein the heat-only automatic activation provides actuation of the unit (10) under detection of a heat signal.

10. The fire extinguishing unit (10) according to claim 8 wherein the heat-and digital-input automatic activation provides actuation through heat cameras, infrared sensors or optical sensors designed to detect radiant energy emitted by burning or glowing particles such that the unit (10) is automatically actuated in the event of such early detection, with a heat-only activation constituting an overriding automatic activation, the digital-input activation functionality further including signalling means for signalling unit (10) activation, including LED lights, a sounding alarm, a SMS/WhatsApp message/push/telegram notifications to one or more dedicated receivers.

11. The fire extinguishing unit (10) according to claim 8 wherein the manual activation and deactivation functionality is done either on a unit-specific basis, or is done on an integrated system wherein the system comprises a number of series or parallel linked units (10).

12. The fire extinguishing unit (10) according to claim 11 wherein the manual operation includes a hard-wired on-site activation functionality through buttons or levers, and a remote activation functionality through a cell phone application.

13. The fire extinguishing unit (10) according to claim 1 wherein the power supply source (42) is a rechargeable, unit-dedicated battery that is connected to an electricity supply or a solar panel.

14. The fire extinguishing unit (10) according to claim 1 wherein the unit (10) includes a heat-resistant mounting cradle.

15. An integrated fire extinguishing system comprising a number of units (10) according to claim 1 arranged in series or parallel throughout a structure.
